(19) United States
(12) Patent Application Publication
(10) Pub. No.: US 2003/0051146 A1
(43) Pub. Date: Mar. 13, 2003

(54) Security realizing system in network

(76) Inventors: Akihiro Ebina, Yokohama (JP); Hideki Kamimaki, Fujisawa (JP); Shinichi Sawamura, Yokohama (JP); Masato Suzuki, Yokohama (JP); Masato Ishii, Yokohama (JP); Yoshinobu Makimoto, Fujisawa (JP); Tatsushi Higuchi, Kisarazu (JP); Isao Takita, Yokohama (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/211,517

(22) Filed: Aug. 5, 2002

(30) Foreign Application Priority Data
Sep. 11, 2001 (JP) 2001-274434

(51) Int. Cl. H04L 9/00

(52) U.S. Cl. 713/185; 380/278

(57) ABSTRACT

In a system for easily realizing security in a homenetwork by preventing communication from being made with a terminal illegally connected to the homenetwork, an information appliance and a key management server are connected to a homenetwork via network connector. By inserting an authentication tag into the information appliance, authentication with the key management server is performed and a public encryption key for allowing communication to be made with another information appliance connected to the homenetwork is obtained, thereby enabling safe communication to be made in the homenetwork.

### BACKGROUND OF THE INVENTION

The invention relates to a data communication system in a homenetwork and, more particularly, data communication of a homenetwork in which a security function is improved by using an authentication tag.

A method of dynamically distributing addresses like a DHCP is generally used as a method of allocating IP addresses to terminals connected to a network. However, the IP addresses are also allocated to terminals which illegally invaded a homenetwork and the network is freely used. Therefore, as a method of disabling the network to be used for the terminals which were illegally connected to the homenetwork, there is a system such that it does not meet requests from addresses other than an MAC address registered in a DHCP server, thereby preventing distribution of addresses to the illegal terminals and restricting the use of the network. There is also means such that an MAC address is registered to an HUB and, when a terminal other than the registered MAC address is connected, communication via its port is disabled, thereby preventing illegal invasion of the network. On the other hand, as shown in JP-A-2001-077811, there is a method whereby security of the homenetwork is assured by providing a security function for a network interface card.

However, according to the method of registering the MAC address into the DHCP server, there is a problem such that the network is easily used by directly designating the IP address to the terminal. In the IPv6 environment, since the address is automatically configurated every terminal, there is no need to know a subnet address in the network and the network can be easily used. According to the method of registering the MAC address into the HUB, since an administrator of the network is necessary and each time the number of apparatuses which are connected increases, it is necessary to make a setup of the HUB. Therefore, when considering the use of the apparatuses in the home, there is a problem such that it is difficult that a person who does not have knowledge of the network manages. According to the method whereby the security function is provided for the network interface card as disclosed in JP-A-2001-077811, since it is necessary to set the security to the network interface card of each terminal, management of the network is difficult and data flowing in the network can be easily tapped or falsified.

### SUMMARY OF THE INVENTION

The invention is made to solve the above problems and it is an object of the invention to provide an apparatus which can easily realize a security of a homenetwork by using a tag, thereby disabling an illegal terminal connected to the homenetwork to use a network and preventing data from being wiretapped. To accomplish the above object, according to the invention, there is realized an information appliance comprising: means which has a slot for reading an authentication tag in which information to use a homenetwork has been recorded and reads the information recorded in the authentication tag when the authentication tag is inserted into the slot; means for recording the information recorded in the authentication tag into the information appliance; means for performing an encryption of transmission data and a decryption of reception data by using an encryption key of the recorded information; and means for performing authentication with a key management server by the encrypted data and receiving a public encryption key which is used in communication in the home, wherein by making encryption communication between the information appliances connected to the homenetwork via network connecting means, confidentiality of the data which is transmitted and received is held.

The key management server comprises: means for authenticating the information appliance connected to the homenetwork; means for managing the information of the information appliance connected to the homenetwork; means for recording information of the key management server into the authentication tag; and means for periodically forming the public encryption key at the time of making communication and distributing it to the information appliance connected to the network, thereby enabling the public encryption key which is used for communication in the home to be periodically changed.

Other objects, features and advantages of the invention will become apparent from the following description of the embodiments of the invention taken in conjunction with the accompanying drawings.

### BRIEF DESCRIPTION OF THE DRAWINGS

FIG. 1 is a constructional diagram of a system;

FIG. 2 is a hardware constructional diagram of an information appliance 101 showing an example of an air conditioner;

FIG. 3 is a hardware constructional diagram of the information appliance 101 in the case where an encryption is performed by the hardware;

FIG. 4 is a hardware constructional diagram of a key management server 103;

FIG. 5 is a detailed hardware constructional diagram of a periphery of a slot 207;

FIG. 6 is a diagram showing data recorded in a memory 307 of an authentication tag 102;

FIGS. 7A and 7B are diagrams showing examples of data recorded in a nonvolatile memory 206;

FIGS. 8A and 8B are diagrams showing examples of table information;

FIG. 9 is a flowchart showing the operation which is executed when the authentication tag 102 is inserted into the information appliance 101; and

FIG. 10 is a flowchart showing the operation which is executed when a power source of the information appliance 101 is turned on.

### DESCRIPTION OF THE EMBODIMENT

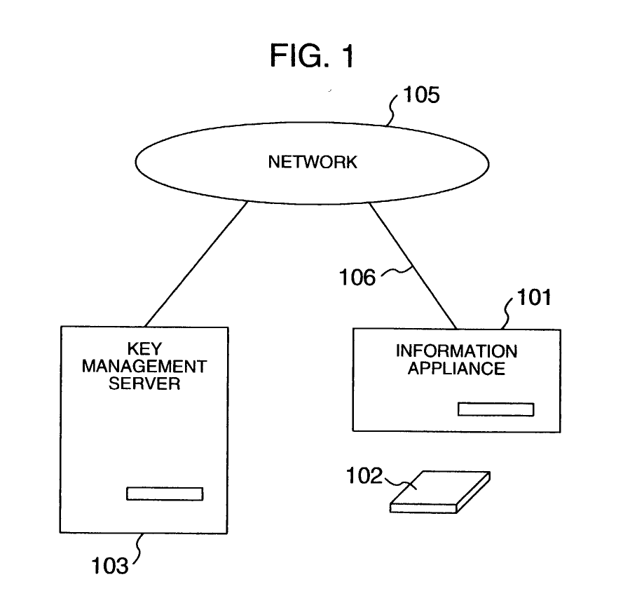

The invention will be described more in detail hereinbelow. FIG. 1 shows a construction of a system showing an example of the invention. Reference numeral 101 denotes an information appliance having network connecting means and means for reading information which has been recorded in an authentication tag and is used in a homenetwork 105. For example, there are information appliances such as personal computer, Internet telephone, Internet refrigerator, Internet air conditioner, and the like which can be connected to the network. Reference numeral 102 denotes an authentication tag in which an encryption key which is used for authentication with a key management server 103, a location of the key management server 103, and a program for performing authentication have been recorded. Reference numeral 103 denotes the key management server for managing a public encryption key which is used in the home; 105 the homenetwork; and 106 network connecting means showing an example according to a wired network.

In the system of the invention, there is realized an information appliance 101 comprising: an apparatus such as a network card or the like which is connected to the network; means which has a slot for reading the authentication tag 102 in which information which is necessary to use the homenetwork 105 has been recorded and reads the information recorded in the authentication tag 102 when the authentication tag 102 is inserted into the slot; means for recording the information recorded in the authentication tag 102 into the information appliance 101; means for performing an encryption of transmission data and a decryption of reception data by using an encryption key of the recorded information; and means for performing authentication with the key management server 103 by using the encrypted data and receiving a public encryption key which is used in communication 2 in the home, wherein encryption communication can be made between information appliances connected to the network 105 via the network connecting means 106.

The encryption key is a key for authentication which is used for communication with the key management server 103. The public encryption key is an encryption key which is used to communicate with the information appliance 101 which is connected to the homenetwork 105 and in which the authentication tag 102 has been inserted. The security denotes that confidentiality of the data is assured by making encryption communication and a situation such that the information appliance 101 in the home is controlled by another terminal which illegally invaded the homenetwork 105 is prevented.

The key management server 103 comprises: means for authenticating the information appliance 101 connected to the homenetwork 105; means for managing the information of the information appliance 101 connected to the homenetwork 105; means for recording information for participating in the homenetwork 105 into the authentication tag 102; and means for periodically forming the public encryption key at the time of making communication and distributing it to the information appliance 101 connected to the network 105, so that the public encryption key which is used for communication in the home is periodically changed, thereby enabling a security intensity to be raised.

If the information necessary to use the homenetwork is not recorded in the authentication tag 102, by inserting the authentication tag 102 into the slot of the key management server 103, the information necessary to use the homenetwork 105 is recorded in the authentication tag 102. By inserting the authentication tag 102 in which the information necessary to use the homenetwork 105 has been recorded into the slot of the information appliance 101, the information appliance 101 executes a procedure for authenticating with the key management server 103 and receives the public encryption key for making communication in the home, so that it can safely make communication with the information appliance 101 connected to the network 105.

By using the method whereby the information necessary to use the homenetwork 105 in the authentication tag 102 is recorded in the information appliance 101, there is no need to keep the system in a state where the authentication tag 102 has been inserted into the information appliance 101. Therefore, the illegal use of the authentication tag 102 can be prevented and merely by managing the authentication tag 102 by the network administrator, the security of the network 105 can be held and a burden on the network administrator can be reduced.

By encrypting the data on the homenetwork 105 and communicating it, even if the data is intercepted by an illegal terminal which invaded the homenetwork 105 and connected thereto, it cannot be decoded. There is no anxiety such that the information appliance 101 in the home is illegally controlled by the illegal terminal. For example, in the wireless network connecting means 106, an access restriction by an MAC address or an access restriction by a password has been performed hitherto and it is necessary to register the MAC address each time the number of apparatuses connected to an access point increases. In an environment in which a roaming function has been implemented, it is necessary to register the MAC addresses every all access points. It is fairly troublesome for the network administrator.

In a system such that an access restriction by a password is performed, it is necessary to change a password of an apparatus connected to the access point each time a password for authentication of the access point is changed. Complicated processes are required for the user of the apparatus. If the setup is not properly performed, there is a possibility that the network 105 is easily invaded. In the network connecting means 106 using an indoor wire for the lamp-light, there is a case where a home in which outlets are installed outside of a house exists. In such a case, it is possible to easily invade the homenetwork 105 in a state where persons in the house are not aware of it.

However, according to the invention, since all of the terminals connected to the homenetwork 105 make communication by same encrypted data, even if the data is intercepted by the terminal which was illegally connected, confidentiality of the data is assured, and security of the network 105 can be easily realized.

The improvement of the security of the homenetwork 105 can be easily realized by executing the simple operation such that the device such as an authentication tag 102 which can be easily understood by the user of the terminal is used and the authentication tag 102 is inserted into the slot provided for the information appliance 101.

One authentication tag 102 is distributed to one family and can be used in common to the information appliance 101 connected to each homenetwork 105. There is no need to annex such a tag to each information appliance 101.

In the network 105 which does not need to change the encryption key which is used in the homenetwork 105 although it depends on a security policy, it is unnecessary to implement the key management server 103 and encrypted data communication using the encryption key recorded in the authentication tag 102 can be also made.

As a service of an ISP or an ASP for managing the Internet, by providing the key management server 103 for the service provider side, each homenetwork 105 which is connected to the ISP or ASP can be managed and new Internet services can be also provided.

In a case where the terminal is carried to the outside of the home and communication is made with an apparatus in the home like a mobile terminal, since the communication is made between the information appliances by using the public encryption that is peculiar to each home, in a portion connecting the homenetwork 105 to an external network, communication with the information appliances in the home can be easily made without executing a process such as a complicated authentication or the like. The information appliances can be easily remote-operated by the mobile terminal from the external network.

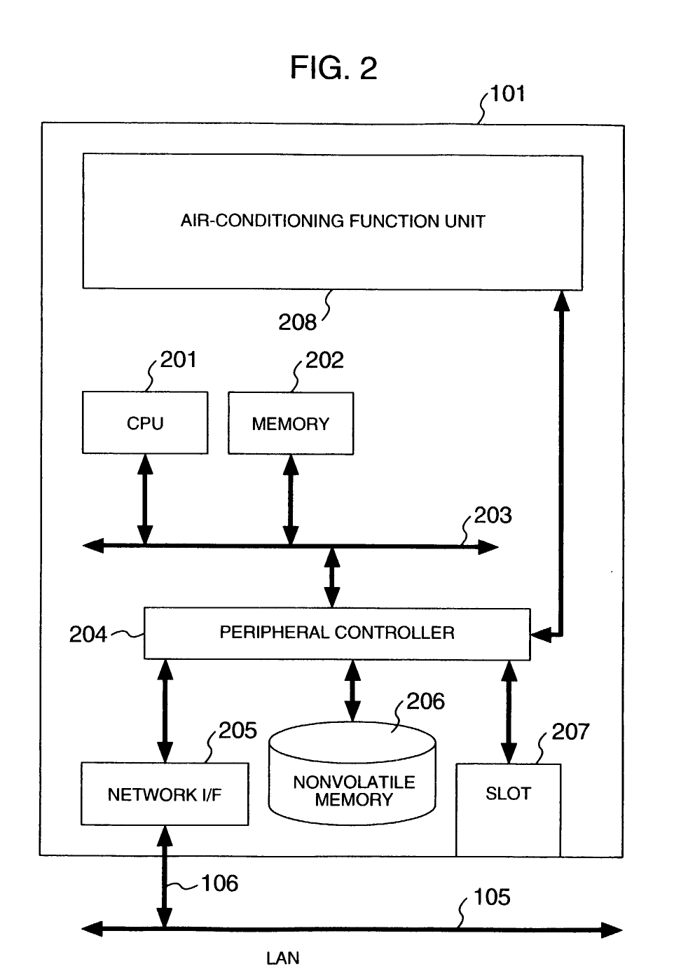

FIG. 2 is a hardware constructional diagram of the information appliance 101 showing an example of an air conditioner. Reference numeral 201 denotes a CPU for detecting the insertion of the authentication tag 102 into a slot 207, executing various programs, and encrypting and decrypting data which is transmitted and received; 202 a memory as an execution area of the program; 203 a bus for transmitting and receiving the data; 204 a peripheral controller for performing a control of a network interface, a control of a nonvolatile memory, a control of the slot, and a control of a temperature adjustment of an air-conditioning function unit 208, ON/OFF of a power source, and the like; 205 a network interface for transmitting and receiving the data; 206 a nonvolatile memory for storing a program which is activated when the authentication tag is inserted into the slot 207, a program for executing encrypting and decrypting processes of the data which is transmitted and received, and the data recorded in the authentication tag 102; 207 the slot for inserting the authentication tag 102; and 208 the air-conditioning function unit serving as a target to be controlled, respectively.

The information appliance 101 has means for developing a program for, when the authentication tag 102 is inserted into the slot 207, allowing the CPU 201 to copy the data recorded in the authentication tag 102 and stored in the nonvolatile memory 206 into an area on the nonvolatile memory 206 which cannot be easily rewritten by the user of the information appliance 101 and cannot be referred to from the network 105 into the memory 202 and executing the program. The information appliance 101 is an apparatus having: means for executing a program which has been recorded in the nonvolatile memory 206 and is used to authenticate with the key management server 103 and a program to execute encrypting and decrypting processes of the data which is transmitted and received after completion of the execution of the above-mentioned program, making encryption communication with the key management server 103 by using an encryption key for authentication, and transmitting information such as MAC address and IP address which are peculiar to the information appliance to the key management server 103 via the network connecting means 106; and means for receiving the public encryption key updated by the key management server 103 by the network interface via the network connecting means 106 and updating the public encryption key recorded in the nonvolatile memory 206.

By having the means for receiving the public encryption key updated by the key management server 103 and updating the public encryption key recorded in the nonvolatile memory 206, the public is periodically changed, so that the advanced security can be realized. Data of the encryption keys held in all of the information appliances 101 connected to the homenetwork 105 can be changed.

A flow of the data received by the information appliance 101 will be described in detail. In the information appliance 101, the peripheral controller 204 stores the encrypted data received by the network interface 205 from the network 105 via the network connecting means 106 into the memory 202 via the bus 203.

The CPU 201 executes the program which has been stored in the nonvolatile memory 206 and is used to execute the encrypting and decrypting processes. The program to execute the encrypting and decrypting processes decodes the encrypted data stored in the memory 202. The CPU 201 deciphers the decrypted data and controls the air conditioner. By operating as mentioned above, the information appliance 101 can be controlled via the network 105 by making communication by the same encrypted data.

Details of the flow when the information appliance 101 transmits the data will be described. The CPU 201 executes the program which has been stored in the nonvolatile memory 206 and is used to execute the encrypting and decrypting processes and encrypts the non-encrypted transmission data stored in the memory 202. The CPU 201 has means for transmitting the encrypted data stored in the memory 202 to the network interface 205 via the peripheral controller 204 and can transmit the encrypted data using the encryption key recorded in the nonvolatile memory 206 to the homenetwork 105.

The program to execute the encrypting and decrypting processes performs the encryption and decryption by DES (Data Encryption Standard) as an encrypting algorithm.

Even in an offline mode in which the information appliance 101 is not connected to the homenetwork 105, by having means which can manually control the air-conditioning function unit 208, the information appliance 101 can use the function of the air conditioner even if the information of the encryption key is not recorded in the nonvolatile memory 206.

The air-conditioning function unit 208 is an example showing a case where the information appliance 101 is the air conditioner and is a portion having a function such as television, VTR, or the like.

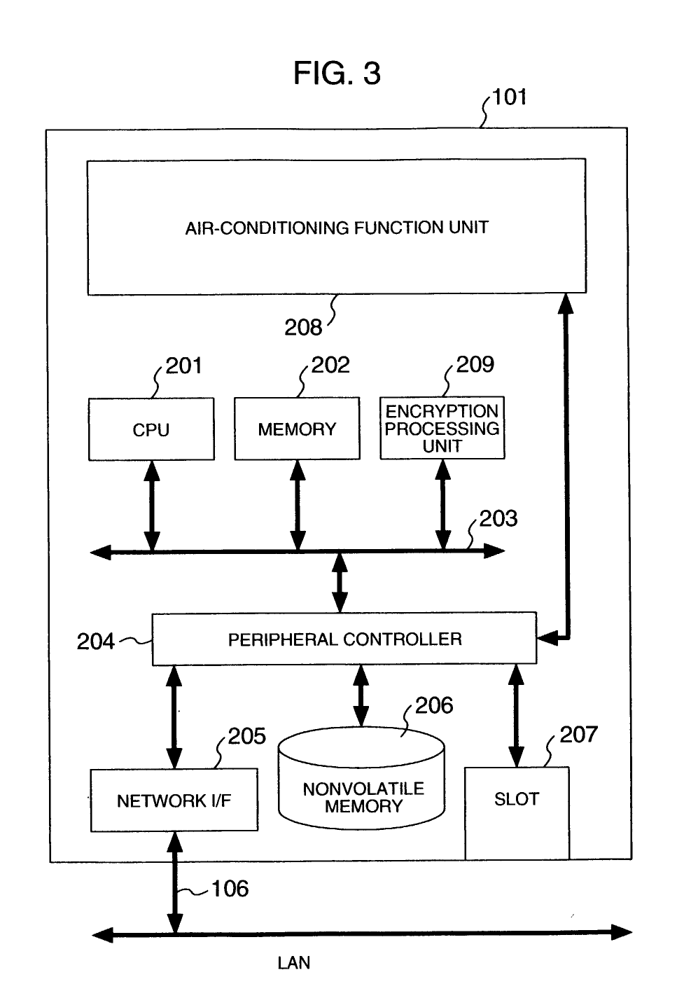

FIG. 3 is a hardware constructional diagram of the information appliance 101 in a case where the encryption is performed by the hardware. Reference numeral 209 denotes an encryption processing unit in which the program to execute the encrypting and decrypting processes of the data mentioned in the foregoing example has been realized by hardware.

A flow in which the information appliance 101 receives data in the case where the encryption is performed by the hardware will be described in detail. In the information appliance 101, the encrypted data received by the network interface 205 from the network 105 via the network connecting means 106 is stored into the memory 202 via the bus 203 by the peripheral controller 204. The CPU 201 has means for transmitting the encrypted data stored in the memory 202 to the encryption processing unit 209. The encryption processing unit 209 has: means for decrypting the encrypted data received from the CPU 201 by using the encryption key recorded in the nonvolatile memory 206; and means for developing the decrypted data into the memory 202.

A flow of the data which is transmitted by the information appliance 101 in the case where the encryption is performed by the hardware will be described in detail. The CPU 201 has means for transmitting the non-encrypted transmission data stored in the memory 202 to the encryption processing unit 209. The encryption processing unit 209 has: means for encrypting the non-encrypted data received from the CPU 201 by using the encryption key recorded in the nonvolatile memory 206; and means for transmitting the encrypted data to the network interface 205 via the peripheral controller 204.

By executing the encryption and decryption by the hardware as mentioned above, the processes can be executed at a high speed and loads of the processes of the CPU 201 can be reduced.

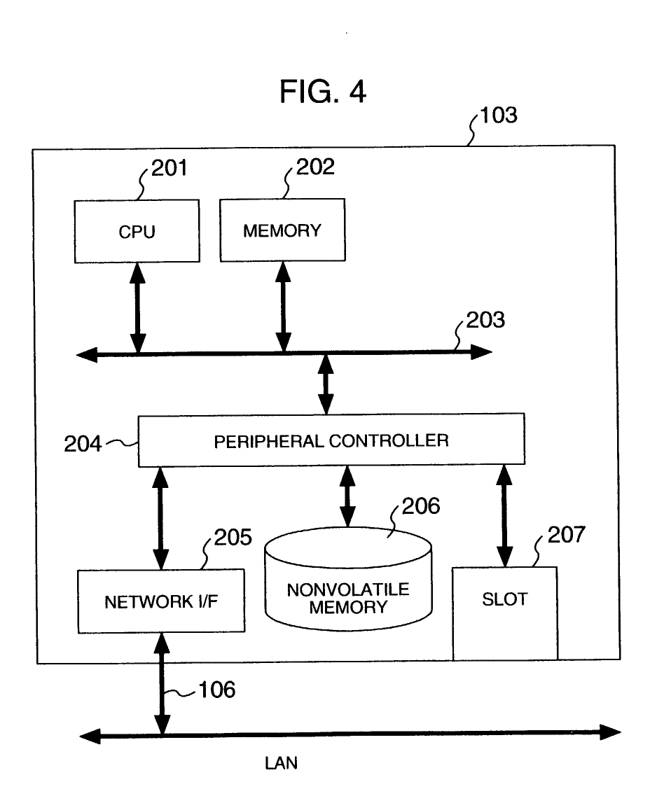

FIG. 4 is a hardware constructional diagram of the key management server 103. The key management server 103 has: means for performing an authenticating procedure with the information appliance 101 by using the encryption key for authentication recorded in the authentication tag 102; and means for receiving information peculiar to the terminal such as MAC address, IP address, etc. which is transmitted from the information appliance 101 via the network connecting means 106 and registering it into the nonvolatile memory 206.

The key management server 103 also has means for developing a program for, when the authentication tag 102 is inserted into the slot 207, allowing the CPU 201 to rewrite the encryption key for authentication in the authentication tag 102 which is used when the information appliance 101 communicates with the key management server 103 by the homenetwork 105 stored in the nonvolatile memory 206 into the memory 202 and executing the program, so that a new encryption key for authentication can be recorded into the authentication tag 102. The key management server 103 also has: means for forming a public encryption key which is used when communication is made between the information appliances 101 connected to the homenetwork 105; and means for transmitting the formed public encryption key to all of the information appliances 101 in the home registered in the nonvolatile memory 206, so that it is possible to realize the safe homenetwork 105 in which the public encryption key is not known by the terminal illegally connected to the network 105, and the public encryption key in the home can be easily changed.

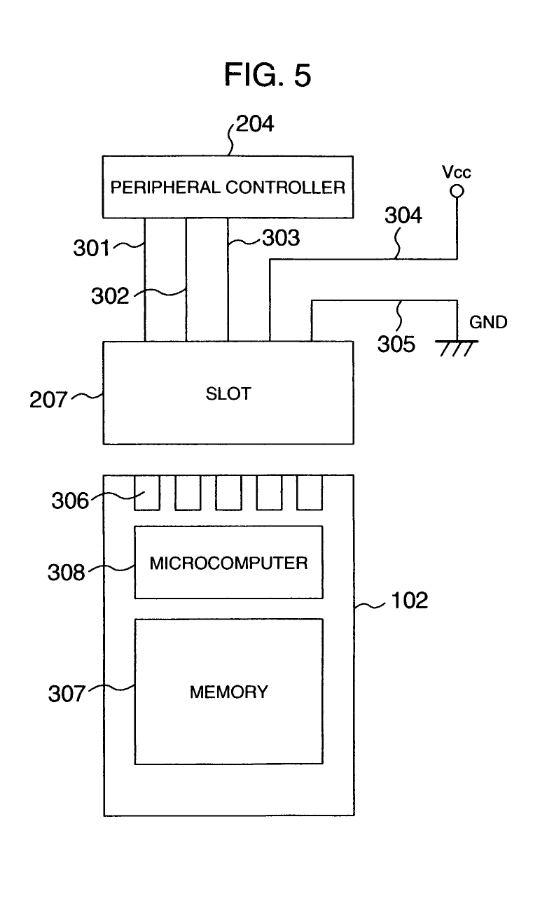

FIG. 5 is a detailed hardware constructional diagram of a periphery of the slot 207. Reference numeral 301 denotes an interrupt signal line for sending an interrupt signal to the CPU 201 when the authentication tag 102 is inserted into the slot 207; 302 a control signal line for sending a read signal and a write signal of the data in a recording area in the authentication tag 102; 303 a data signal line for transmitting the data into the recording area in the authentication tag 102 and receiving the data recorded in the recording area in the authentication tag 102; 304 a power input line for supplying a power source to the authentication tag 102; 305 a ground line; 306 connecting terminals for connecting the authentication tag 102 to the various signal lines connected to the slot 207; 307 a rewritable nonvolatile memory in which information necessary to use the homenetwork 105 has been recorded; and 308 a microcomputer for controlling the authentication tag 102.

According to the above construction, when the authentication tag 102 is inserted into the slot 207 of the information appliance 101, the power input connecting terminal 306 of the authentication tag 102 is connected to the power input line 304, so that an electric power is supplied to the microcomputer 308 in the authentication tag 102. The microcomputer 308 transmits the interrupt signal to the CPU 201 of the information appliance 101 via the interrupt signal line 301, and the CPU 201 of the information appliance 101 receives the interrupt signal. The information appliance 101 has means constructed in a manner such that the CPU 201 of the information appliance 101 executes the program which has been stored in the nonvolatile memory 206 and is used to extract the necessary information which has been recorded in the memory 307 in the authentication tag 102 and is necessary for using the homenetwork. The information appliance 101 also has means constructed in a manner such that the program transmits the read signal via the control signal line 302, the microcomputer 308 transmits the information which has been recorded in the memory 307 in the authentication tag 102 and is necessary for using the homenetwork to the information appliance 101 via the data signal line 303, and the CPU 201 records the information into the nonvolatile memory 206. Thus, the information appliance 101 for receiving the information necessary for using the homenetwork of the information appliance 101 can be realized.

With the above construction, similarly, the key management server 103 has: means for executing a program for allowing the CPU 201 of the key management server 103 in a manner such that when the authentication tag 102 is inserted into the slot 207 of the key management server 103, the encryption key for authentication which has been stored in the nonvolatile memory 206 and is used for authentication with the key management server 103 is formed and the encryption key for authentication which has been recorded in the authentication tag 102 and is used for authentication with the key management server 103 is rewritten. The key management server 103 also has means for rewriting, via the data signal line 303, the information which has been recorded in the memory 307 in the authentication tag 102 inserted into the slot 207 of the key management server 103 and is used for using the homenetwork 105. Thus, the encryption key for authentication in the authentication tag 102 can be changed each time the authentication tag 102 is inserted into the slot 207 of the key management server 103.

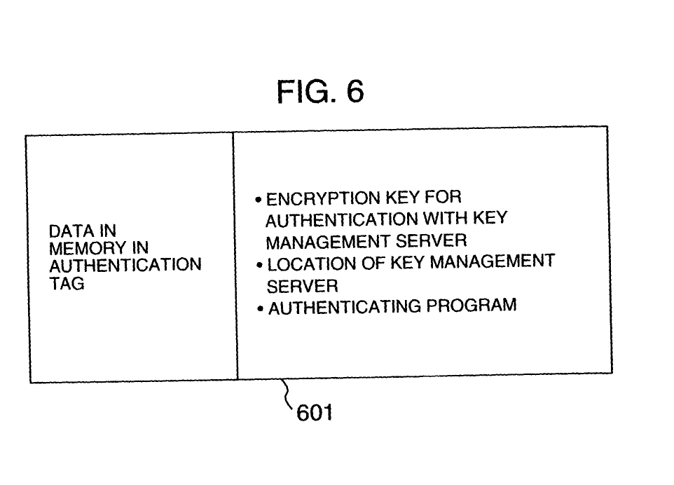

FIG. 6 is a diagram showing the data recorded in the memory 307 of the authentication tag 102. Reference numeral 601 denotes a table showing the data recorded in the memory 307 in the authentication tag 102. The authentication tag 102 has means constructed in a manner such that when the authentication tag 102 is inserted into the slot 207 of the information appliance 101, the microcomputer 308 receives the read signal from the peripheral controller 204, and the microcomputer 308 reads out the encryption key for authentication with the key management server 103 which has been recorded in the memory 202 in the authentication tag 102, a location of the key management server 103, for example, a location such as an IP address in the homenetwork 105, and an authenticating program with the key management server 103 and transmits them to the information appliance 101. Thus, the information appliance 101 stores the encryption key for authentication with the key management server 103 which has been recorded in the authentication tag 102 and is information necessary for using the homenetwork 105, the location of the key management server 103, and the authenticating program into the nonvolatile memory 206 in the information appliance 101, specifies the location of the key management server 103 in the homenetwork 105 from the location information of the key management server 103. Whereby, the information appliance 101 executes the authenticating program, thereby performing the authentication with the key management server 103 by using the encryption key for authentication with the key management server 103 and receiving the public encryption key in the homenetwork 105 from the key management server 103, so that it is possible to communicate with the information appliance 101 connected to the homenetwork 105.

Similarly, the information appliance 101 has means constructed in a manner such that when the authentication tag 102 is inserted into the slot 207 of the key management server 103, the microcomputer 308 receives the write signal from the peripheral controller 204 and writes the encryption key for authentication with the key management server 103, the location of the key management server 103, and the authenticating program into the memory 307 in the authentication tag 102.

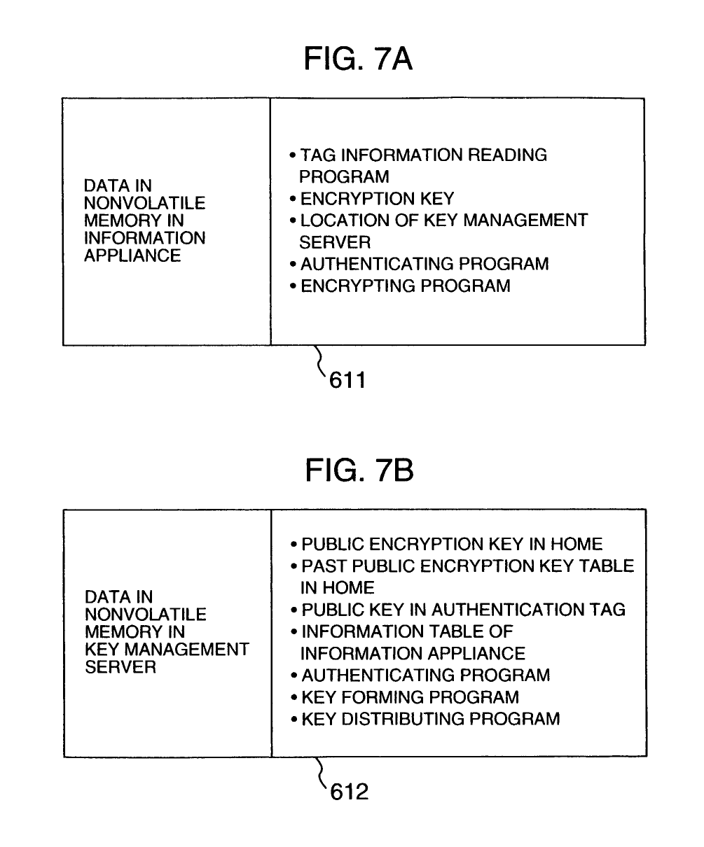

FIGS. 7A and 7B are diagrams showing examples of the data recorded in a nonvolatile memory 206. Reference numeral 611 denotes a table showing the data recorded in the nonvolatile memory 206 of the information appliance 101. A tag information reading program is a program which has previously been installed in all of the information appliances 101 and which is executed when the authentication tag 102 is inserted into the slot 207 of the information appliance 101, and is a program for copying the encryption key for authentication with the key management server 103 which has been recorded in the memory 307 in the authentication tag 102, the location of the key management server 103, and the authenticating program into the nonvolatile memory 206. After the program was executed, the authenticating program stored in the nonvolatile memory 206 and the preinstalled encrypting program are activated and communication with the key management server 103 is made by the encrypted data using the encryption key for authentication. According to the authenticating program, the information of the information appliance 101 such as IP address, MAC address, etc. of the information appliance 101 is registered into the key management server 103, the information appliance 101 receives the public encryption key used by the network 105 via the network connecting means 106 and updates the encryption key in which the received public encryption key has been used for authentication with the key management server 103 into a public encryption key used by the network 105. The encrypting program uses the public encryption key at the time of the next communication. Thus, it is possible to make communication with another information appliance 101 connected to the network 105.

In case of executing the encrypting process of the information appliance 101 by hardware, it is not always necessary to preinstall the encrypting program. A mechanism such that the encrypting program is distributed by the authentication tag 102 can be also used.

By adding a mechanism such that a table in which a plurality of encryption keys can be registered is held in the nonvolatile memory 206 of the key management server 103, a plurality of different encryption keys can be held and it is also possible to make communication with a specific information appliance. For example, when a manufacturer sells the information appliance 101, the authentication tag 102 in which the different encryption key has been recorded every information appliance 101 that is unique to the manufacturer is enclosed in the information appliance. The user of the information appliance 101 in the home inserts the authentication tag 102 which is used in the home into the slot 207 and inserts the enclosed authentication tag 102 into the slot 207, thereby enabling the information appliance 101 to have two encryption keys. The manufacturer makes communication by using the encryption key recorded in the authentication tag 102 enclosed in the information appliance 101, so that it can communicate with only the specific information appliance 101 in the home. Maintenance and information collection of the specific information appliance 101 can be safely and easily performed. Even if the manufacturer invades the homenetwork 105, since the public encryption key which is used in the homenetwork 105 and the encryption of the manufacturer are different, interception of communication data flowing in the homenetwork 105 or an illegal control of other information appliances 101 can be prevented.

Reference numeral 612 is a table showing the data recorded in the nonvolatile memory 206 in the key management server 103. The following items have been recorded in the nonvolatile memory 206 in the key management server 103: that is, the public encryption key which is used for communicating with the information appliance 101 connected to the homenetwork 105; a public encryption key table of the past public encryption keys in the home which is used for recording the public encryption key which is used at present when the public encryption key which is used in the homenetwork 105 is changed; the same public key for authentication as the public key for authentication recorded in the authentication tag 102; an information table of the information appliance; an authenticating program for authenticating with the information appliance 101 and registering the information into the information table of the information appliance; a key forming program for forming the public encryption key in the homenetwork 105 and the encryption key for authentication; and a key distributing program for distributing the public encryption keys recorded in the nonvolatile memory 206 in each of the key management server 103 and the information appliance 101 only to the information appliance 101 included in the information table of the information appliance.

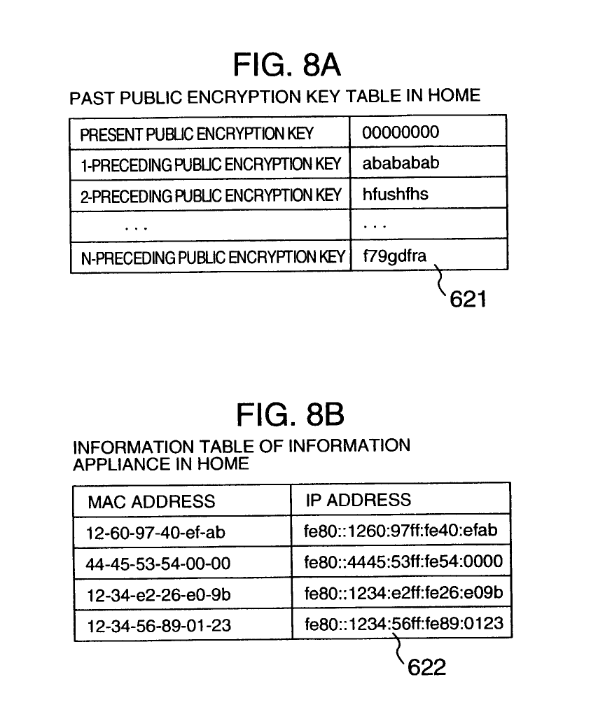

FIGS. 8A and 8B are diagrams showing examples of the table information recorded in the nonvolatile memory 206 in the key management server 103. Reference numeral 621 denotes a public encryption key table of the past public encryption keys in the home and 622 indicates an information table of the information appliance.

The key management server 103 has means constructed in a manner such that a public encryption key in the homenetwork 105 is newly formed, when the newly formed public encryption key is distributed to the information appliance 101 connected to the homenetwork 105, an encryption is performed by using the present public encryption key, the public encryption key which was newly formed is distributed, and the newly formed public encryption key is registered into the present public encryption key in the past public encryption key table 621 in the home.

With respect to the past public encryption key table 621 in the home, the MAC address and the IP address of the information appliance 101 have been registered. By distributing the newly formed public encryption key to the IP address included in the public encryption key table 621 in the home, the newly formed public encryption key can be distributed only to the information appliance 101 registered in the homenetwork 105.

Since the IPv6 network has a mechanism such that a link local address is automatically configurated from the MAC address. Merely by registering only the IP address into the information table 622 of the information appliance, the MAC address of the information appliance 101 can be easily known.

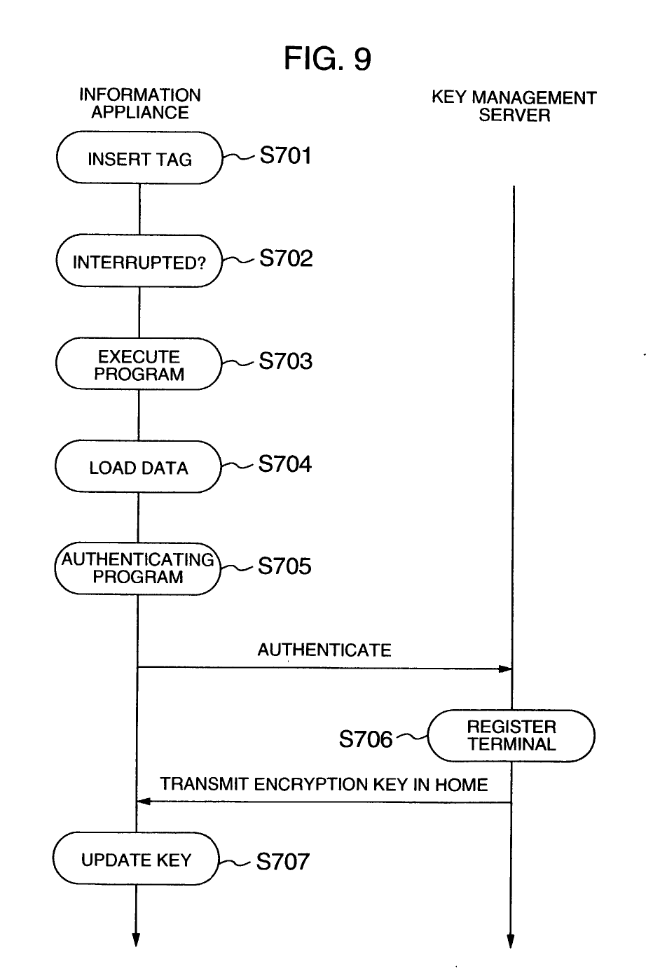

FIG. 9 is a flowchart showing a flow of processes which are executed after the authentication tag 102 was inserted into the information appliance 101 until the information appliance 101 obtains the public encryption key in the homenetwork 105. The authentication tag 102 is inserted into the slot 207 of the information appliance 101 (step 701). Subsequently, the authentication tag 102 generates an interrupt signal to the CPU 201 via the interrupt signal line 301 (step 702). When the interrupt signal transmitted from the authentication tag 102 is received, the CPU 201 executes the tag information reading program stored in the nonvolatile memory 206 (step 703). The tag information reading program copies the information recorded in the memory 307 in the authentication tag 102 into the nonvolatile memory 206 (step 704). The information appliance 101 executes the authenticating program copied in step 704 by using the encryption key for authentication which was copied in step 704 and enables communication with only the key management server 103, thereby performing the authentication with the key management server 103 (step 705). The key management server 103 performs the authentication with the information appliance 101, thereby storing the MAC address or IP address as a table into the key management server 103 and transmits the public encryption key which is used in the homenetwork 105 to the information appliance 101 (step 706).

Receiving the public encryption key which is used in the homenetwork 105 from the key management server 103, the information appliance 101 changes the encryption key for authentication which was copied into the nonvolatile memory 206 in step 704 and is used upon communication with the key management server 103 to the public encryption key which is used in the homenetwork 105 (step 707). By the operation as mentioned above, the information appliance 101 can communicate with another information appliance 101 which has been registered in the key management server 103 and connected to the homenetwork 105. For example, if the homenetwork 105 is an IPv6 network 105, the information appliance 101 automatically configurates the link local address which can be used only in the homenetwork 105. The information appliance 101 makes encryption communication with the key management server 103 by using the link local address, and can update the encryption key to the public encryption key for communicating with another information appliance 101 connected to the homenetwork 105. Since the system has a mechanism such that as a global address necessary for using an external network, an address is distributed by a terminal having a router function, by making the encryption communication by using the public encryption key, the information appliance 101 can obtain the global address from a router which can make the encryption communication using the same public encryption key. As mentioned above, a situation that the global address is distributed to the information appliance 101 illegally connected to the homenetwork 105 can be prevented. A situation that the homenetwork 105 is illegally used by the illegally connected information appliance 101 can be prevented.

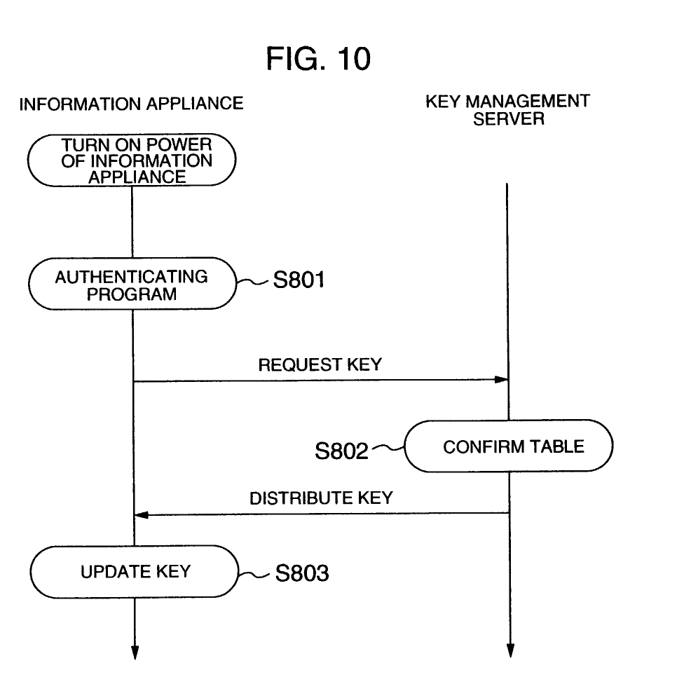

FIG. 10 is a flowchart showing the operation which is executed when a power source of the information appliance 101 registered in the key management server 103 is turned on. The information appliance 101 connected to the homenetwork 105 executes the authenticating program recorded in the nonvolatile memory 206 at the time of turn-on of the power source and requests the key management server 103 for the public encryption key used in the homenetwork 105 by using the public encryption key recorded in the nonvolatile memory 206 (step 801).

The key management server 103 receives the request from the information appliance 101 from the past public encryption key table in the home in the nonvolatile memory 206 by using the past public encryption key which enables the communication with the information appliance 101. The key management server 103 discriminates whether the MAC address of the information appliance 101 which requested in step 801 exists in the information table of the information appliance in the nonvolatile memory 206 or not, and transmits the public encryption key which is used in the homenetwork 105 to the information appliance 101 (step 802).

The information appliance 101 receives the public encryption key which is used in the homenetwork 105 from the key management server 103 and stores it into the nonvolatile memory 206 (step 803). If the public encryption key which is used in the homenetwork 105 is updated at the time of turn-off of the power source or the like of the information appliance 101, the information appliance 101 cannot update the public encryption key in the nonvolatile memory 206. When the power source is turned on again, since the public encryption key which is used in the homenetwork 105 by another information appliance 101 differs from the public encryption key of the information appliance 101, the communication cannot be performed. However, since the information appliance 101 operates as mentioned above, the information appliance 101 can change the encryption key to the public encryption key which is used in the homenetwork 105 upon turn-on of the power source and can smoothly make communication.

As described above, according to the invention, by inserting the authentication tag managed in the home into the information appliance, there is no need to perform a complicated setup and management, the security of the homenetwork 105 can be easily realized. By encrypting the data flowing in the homenetwork 105, even if the data flowing in the network 105 is intercepted by the illegal terminal which invaded the homenetwork 105, the data cannot be deciphered. The illegal control to the information appliance in the network 105 can be prevented.

The invention is not limited to the foregoing embodiment but many modifications and variations are naturally possible without departing from the spirit of the invention irrespective of an applying field. For example, the invention is not limited to the IPv6 protocol but can be applied to another protocol so long as the invention can be embodied. The terminal which is connected to the network is not limited to the information appliance but can be applied to other terminals so long as they are connected to the network. Further, the network is not limited to the homenetwork.

What is claimed is:

1. A terminal having network connecting means, comprising:
a slot for reading an authentication tag in which information for using a network has been recorded,
wherein by inserting said authentication tag, data can be transmitted and received between information appliances connected to said network.

2. A terminal according to claim 1, further comprising:
means for reading the information recorded in said authentication tag when the authentication tag is inserted into said slot of the terminal;
means for recording the information recorded in said authentication tag into the terminal; and
means for performing an encryption of transmission data and a decryption of reception data by using an encryption key of the recorded information.

3. A terminal according to claim 1, further comprising:
means for copying a program recorded in said authentication tag onto a recording medium which the terminal possesses; and
means for executing the copied program.

4. A terminal according to claim 1, further comprising:
means for transmitting information peculiar to the terminal to a key management server; and
means for receiving a public encryption key updated by said key management server and updating the public encryption key recorded in the terminal.

5. A terminal according to claim 4, wherein said key management server further comprises:
means for authenticating the terminal connected to the network; and
means for recording information of the terminal connected to said network as a table into said key management server and managing it.

6. A terminal according to claim 5, wherein said key management server further comprises:
means for forming an encryption key; and
means for distributing said encryption key to the terminal connected to said network on the basis of said table information.

7. A security system comprising:
a terminal apparatus having a slot into which an authentication tag is inserted;
a key management server having a slot into which said authentication tag is inserted; and
a network for connecting said terminal apparatus to said key management server,
wherein said key management server records first key information into said authentication tag,
said terminal apparatus reads out second key information recorded in said authentication tag and transmits said second key information to said key management server via said network, and
said key management server compares said second key information with said first key information stored in said key management server and, when said first key information and said second key information coincide, said key management server transmits third key information for enabling said terminal apparatus to access another apparatus connected to said network to said terminal apparatus.

8. A system according to claim 7, wherein said third key information can be updated.

9. An information appliance which can be connected to a network, comprising:
a slot into which an authentication tag is inserted;
a portion for reading out information recorded in said authentication tag;
a portion for transmitting said read-out information onto said network; and
a portion for receiving information which corresponds to the information transmitted onto said network and shows that said information appliance can be used.

10. A key management server which can be connected to a network, comprising:
a slot into which an authentication tag is inserted;
a portion for forming key information for authenticating another apparatus connected to said network; and
a portion for storing said key information into said authentication tag inserted into said slot.

11. A server according to claim 10, further comprising:
a portion for receiving authentication information outputted from said another apparatus connected to said network;
a portion for comparing said authentication information with authentication information stored in said key management server; and
a portion for transmitting a result of said comparison to said another apparatus.
